(19) United States
(12) Patent Application Publication
(10) Pub. No.: US 2019/0326851 A1
(43) Pub. Date: Oct. 24, 2019

(54) SOLAR PANEL FRAME ASSEMBLY

(71) Applicant: Jia-Shou WANG, NEW TAIPEI CITY (TW)

(72) Inventor: Jia-Shou WANG, NEW TAIPEI CITY (TW)

(21) Appl. No.: 16/389,427

(22) Filed: Apr. 19, 2019

(30) Foreign Application Priority Data
Apr. 20, 2018 (TW) 107113506

(51) Int. Cl. H02S 30/10; F24S 25/20; F24S 25/67; H02S 20/23

(52) U.S. Cl. CPC H02S 30/10; H02S 20/23; F24S 25/67; F24S 25/20

(57) ABSTRACT

A solar panel frame assembly includes a rectangular frame formed of two opposed transverse bars and two opposed longitudinal bar and holding therein a solar panel. The rectangular frame defines a top surface and an opposing bottom surface. Each longitudinal bar has an outer side thereof provided with a hanging portion. When the solar panel frame assembly is disposed on a beam frame structure, the hanging portions of the longitudinal bars are hooked on respective stringers of the beam frame structure.

### BACKGROUND OF THE INVENTION

### 1. Field of the Invention

The present invention relates to solar energy equipment and more particularly, to a solar panel frame assembly.

### 2. Description of the Related Art

In order to encourage the use of alternative energy sources, solar energy is a kind of green energy that the government is pushing forward. However, solar panels are currently installed in a rectangular frame, and then the rectangular frame is installed on an iron frame outside the roof or the outer wall of the building, and the rectangular frame holding the solar panel is not directly taken as a building material on the roof or used as an exterior wall. In the case of a roof, it is necessary to make a roof on the building and then mount the iron frame on the roof. Finally, the rectangular frame holding the solar panel is fastened to the iron frame using complicated clips or fixtures. Therefore, in the same area, it is equivalent to a two-layer roof. This installation method is a waste of space and materials.

### SUMMARY OF THE INVENTION

The present invention has been accomplished under the circumstances in view. It is the main object of the present invention to provide a solar panel frame assembly, which can be directly used as a roof and has good waterproof and drainage effects.

To achieve this and other objects of the present invention, a solar panel frame assembly comprises a rectangular frame formed of two opposed transverse bars and two opposed longitudinal bars. The rectangular frame holds therein a solar panel and defines a top surface and an opposing bottom surface. Each longitudinal bar has an outer side thereof provided with a hanging portion. The hanging portion comprises a transverse segment and a longitudinal segment. The transverse segment extends from the outer side of the associating longitudinal bar along the long axis direction of the transverse bars. The longitudinal segment extends from a distal end of the transverse segment toward the bottom surface of the rectangular frame.

Preferably, each of the two transverse bars has an outer side thereof provided with a hanging portion. The orientation of the hanging portion at one transverse bar is opposite to the orientation of the other three hanging portions.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a solar panel frame assembly in accordance with a first embodiment of the present invention.

FIG. 2 is a back side view of the solar panel frame assembly in accordance with the first embodiment of the present invention.

FIG. 3 illustrates a beam frame structure for supporting the solar panel frame assembly in accordance with the present invention.

FIG. 4 is a schematic sectional view, illustrating the hanging portions of the solar panel frame assembly of the first embodiment hooked on one stringer of the beam frame structure.

FIG. 5 is a schematic view of a part of a second embodiment of the present invention, illustrating the configuration of a hanging portion.

FIG. 6 is a back side view of a solar panel frame assembly in accordance with a third embodiment of the present invention.

FIG. 7 is a side view of the solar panel frame assembly in accordance with the third embodiment of the present invention.

FIG. 8 is a schematic drawing illustrating two solar panel frame assemblies in accordance with the third embodiment of the present invention hooked up together.

FIG. 9 is a back side view of a solar panel frame assembly in accordance with a fourth embodiment of the present invention.

FIG. 10 is an oblique top elevational view of a solar panel frame assembly in accordance with a fifth embodiment of the present invention.

FIG. 11 is a schematic drawing illustrating the solar panel frame assemblies in accordance with the fifth embodiment of the present invention installed in a beam frame structure.

### DETAILED DESCRIPTION OF THE INVENTION

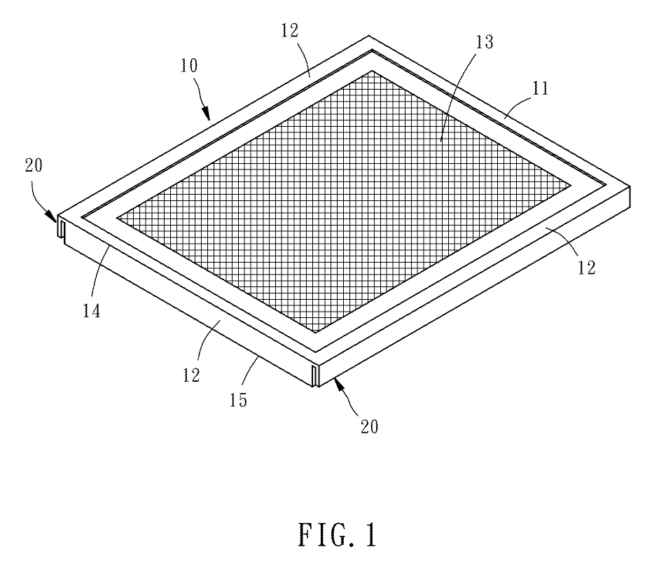

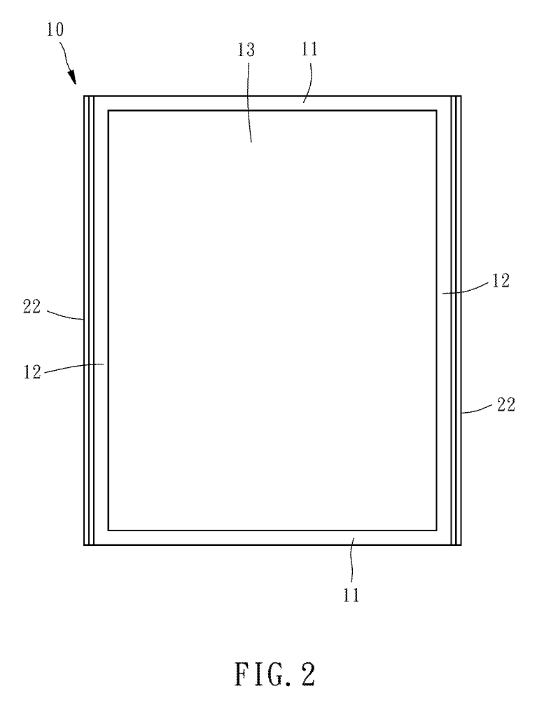

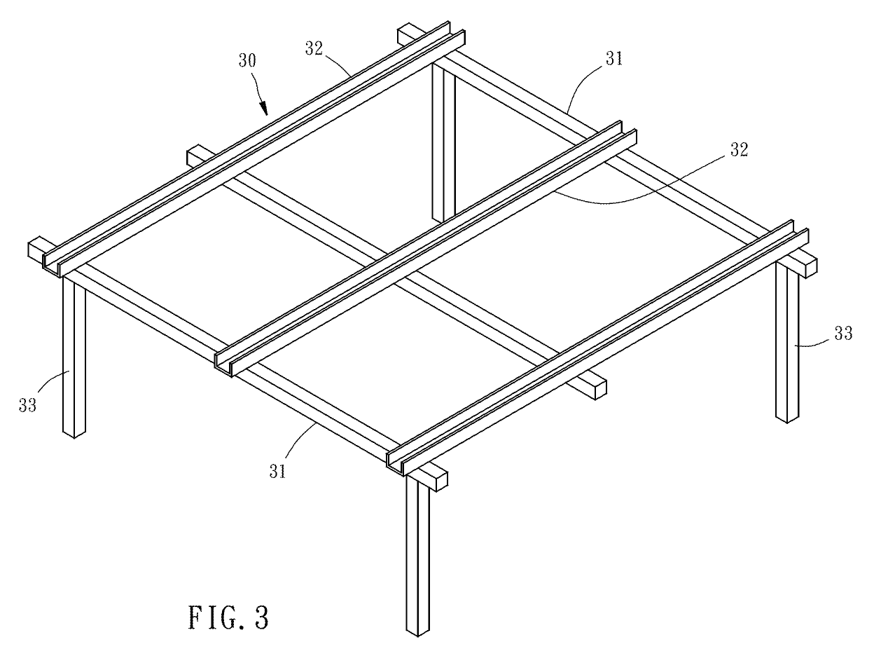

Referring to FIGS. 1-4, a solar panel frame assembly in accordance with a first embodiment of the present invention is shown. The solar panel frame assembly comprises a rectangular frame 10 formed of two opposed transverse bars 11 and two opposed longitudinal bar 12. The rectangular frame 10 holds therein a solar panel 13 and defines a top surface 14 and an opposing bottom surface 15.

Each longitudinal bar 12 has a hanging portion 20 provided at an outer side thereof. The hanging portion 20 has a transverse segment 21 and a longitudinal segment 22. The transverse segment 21 extends integrally outwardly from the outer side of the longitudinal bar 12 along the long axis direction of the transverse bar 11. The longitudinal segment 22 extends from the extended end of the transverse segment 21 toward the bottom surface 15 of the rectangular frame 10, such that a gap 23 is formed between the longitudinal segment 22 and the adjacent longitudinal bar 12.

The transverse segment 21 may extend outwardly from any position of the outer side of the longitudinal bar 12, preferably extending from the top surface 14 of the rectangular frame 10 along the long axis direction of the transverse bar 11.

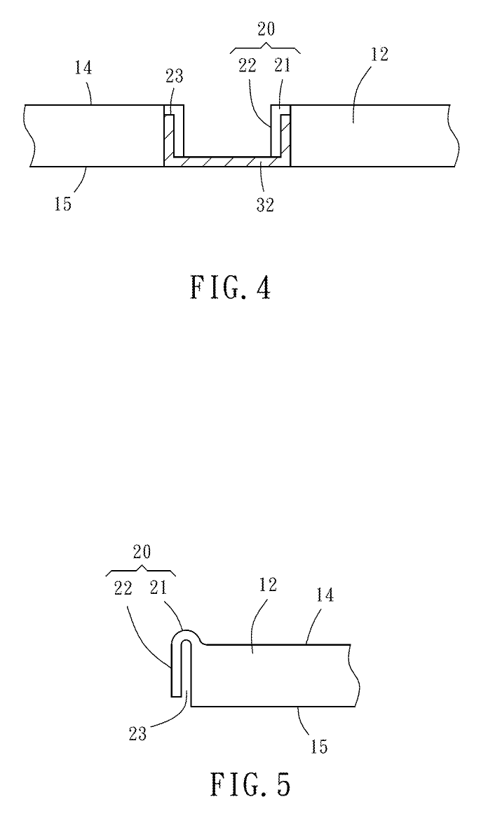

The beam frame structure 30 for supporting a roof or the solar panel frame assembly includes a plurality of beams 31 and a plurality of stringers 32, and the bottom side is supported by a plurality of posts 33. The stringers 32 are U-beams and the U-shaped opening is facing up. When the solar panel frame assembly is disposed on the beam frame structure 30, the hanging portions 20 of the longitudinal bars 12 are hooked on the respective stringers 32 of the beam frame structure 40, enabling the rectangular frame 10 to be hung between two adjacent stringers 32 of the beam frame structure 40. Preferably, each of the two opposite sidewalls of the stringers 32 can fall within the gap 23 between the longitudinal segment 22 and the adjacent longitudinal bar 12, as shown in FIG. 4. In this way, the rectangular frame 10 of the solar panel frame assembly can be made into a waterproof joint with the stringer 32. The top surface 14 of the solar panel frame assembly faces outward, so when there is rain, the rain falls into the stringers 32 along the top surface 14 of the solar panel frame assembly and the transverse surface 21 of the hanging portion 20 to make the stringer 32 function like a trough or drain. To further enhance the sealing and waterproof effect, a waterproof gasket can be added to the gap 23 to improve the waterproof effect.

The form of the hanging portion 20 in the present invention is not limited to the one described in the aforesaid first embodiment, and may be as shown in FIG. 5, which is a second embodiment of the present invention. This second embodiment is substantially similar to the aforesaid first embodiment with the exception that the transverse segment 21 of the hanging portion 20 is arch-shaped, and the longitudinal segment 22 is extended from the distal end of the arch-shaped transverse segment 21 toward the bottom surface 15 of the solar panel frame assembly. The installation procedure of this second embodiment is same as that of the aforesaid first embodiment, i.e., the hanging portion 20 of each longitudinal bar 12 is hooked on one respective stringer 32 of the beam frame structure 40, enabling each of the two opposite sidewalls of the stringers 32 to fall within the gap 23 between the respective longitudinal segment 22 and the adjacent longitudinal bar 12. The configuration of the hanging portion 20 of the present invention is not limited to the aforesaid first embodiment and the aforesaid second embodiment.

In the present invention, the hanging portion 20 is not limited to be disposed only outside the two longitudinal bars 12 of the rectangular frame 10, and the outer side of the transverse bar 11 may be disposed, so the rectangular frame 10 may have three or four hanging portions 20. The shape of the hanging portions 20 of the transverse bars 11 does not need to be the same as the shape of the hanging portions 20 of the longitudinal bars 12. The hanging portions 20 of the longitudinal bars 11 may be as shown in the first embodiment, and the hanging portions 20 of the transverse bars 11 may be in another form.

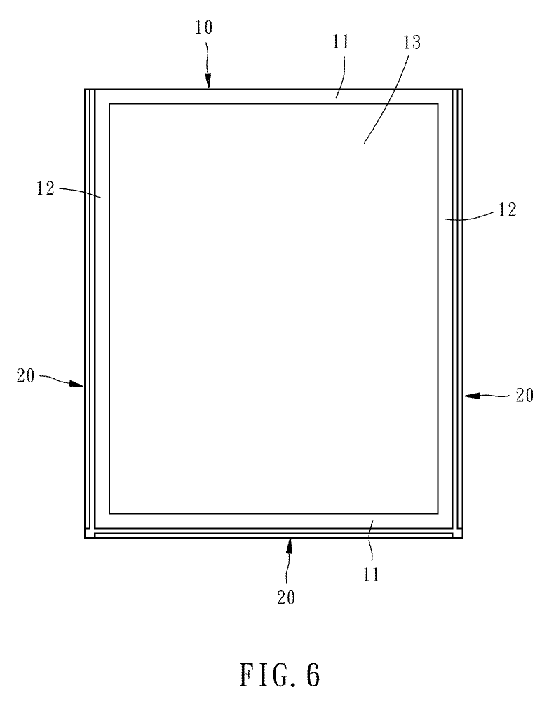

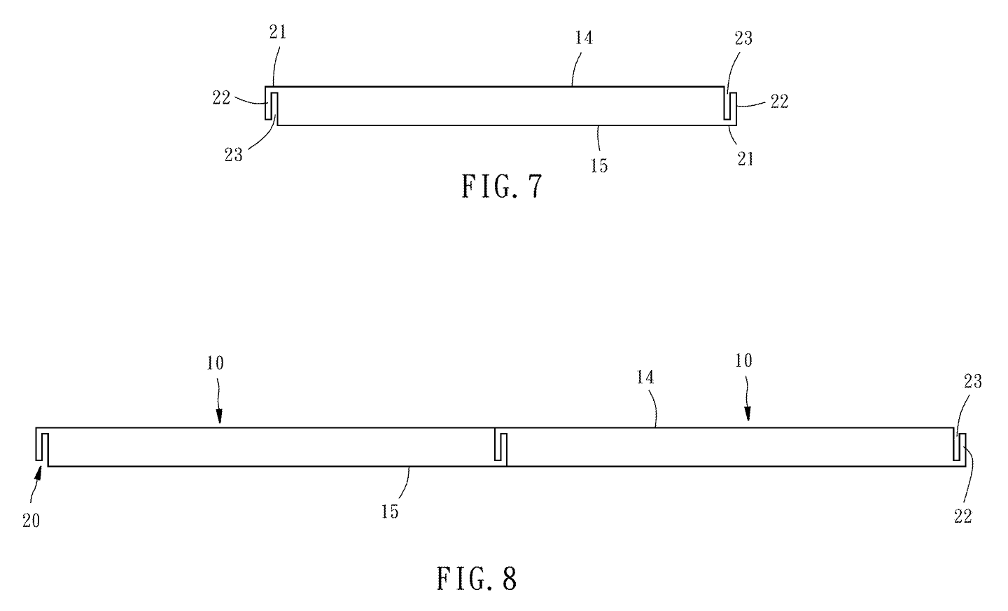

FIGS. 6-8 illustrate a solar panel frame assembly in accordance with a third embodiment of the present invention. The solar panel frame assembly comprises a rectangular frame 10 formed of two opposed transverse bars 11 and two opposed longitudinal bar 12. The rectangular frame 10 holds therein a solar panel 13 and defines a top surface 14 and an opposing bottom surface 15. This third embodiment is different from the aforesaid first embodiment in that each of the transverse bar 11 and each of the longitudinal bar 12 is provided with a hanging portion 20, so the rectangular frame 10 has four hanging portions 20. The arrangement of the hanging portions 20 of the two longitudinal bars 12 is same as the aforesaid first embodiment, and one of the two transverse bars 11 is provided with a hanging portion 20 that is same as the hanging portion 20 of each longitudinal bar 12. Moreover, the direction of the gap 23 is also oriented toward the bottom surface 15 of the solar panel frame assembly. The other transverse bar 11 is also provided with a hanging portion 20, however, the direction of the handing hook 20 of the other transverse bar 11 is opposite to the direction of the gaps 23 of the other three hanging portions 20.

Therefore, the longitudinal segment 22 of the hanging portion 20 of one transverse bar 11 is formed to extend toward the top surface 14 of the solar panel frame assembly, and the other longitudinal segments 22 of the other three hanging portions 20 extend toward the bottom surface 15 of the solar panel frame assembly.

When the solar panel frame assembly of this third embodiment is disposed on the beam frame structure 30, the hanging portions 20 of the longitudinal bars 12 are hooked on the respective stringers 32 of the beam frame structure 40, enabling the U-shaped sidewalls of the stringers 32 to fall within the gaps 23 between the respective longitudinal segments 32 and the respective adjacent longitudinal bars 12. However, two adjacent solar panel assemblies can be mutually hooked using the hanging portions 20 of the adjacent transverse bars 11, i.e., the longitudinal segment 22 of the hanging portion 20 of one transverse bar 11 of the rectangular frame 10 of one solar panel frame assembly is inserted into the gap 23 in the hanging portion 20 of the transverse bar 11 of the other solar panel frame assembly, as shown in FIG. 8. Thereby, a plurality of solar panel frame assemblies can be formed into a continuous connection structure, and a good connection and waterproof effect can be formed between the solar panel frame assemblies.

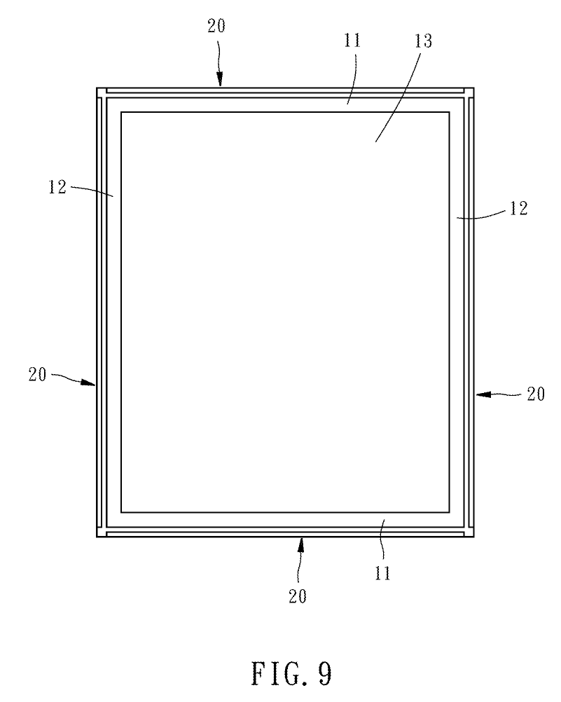

Of course, the hanging portions 20 set on the outer edge of the rectangular frame 10 can also be set in the same direction. As shown in FIG. 9, in the fourth embodiment of the present invention, the two transverse bard 11 and the two longitudinal bars 12 of the rectangular frame 10 are respectively provided with a hanging portion 20. Each hanging portion 20 comprises a transverse segment 21 and a longitudinal segment 22. The transverse segment 21 extends integrally outwardly from the outer edge of the longitudinal bar 12 along the direction of the long axis of the transverse bar 11, and the longitudinal segment 22 extends from the extended end of the transverse segment 21 toward the bottom surface 15 of the rectangular frame 10, so a gap 23 is formed between the longitudinal segment 22 and the adjacent longitudinal bar 12. When the solar panel frame assembly of this fourth embodiment is disposed on the beam frame structure 30, the hanging portions 20 are hung on the beam frame structure 30.

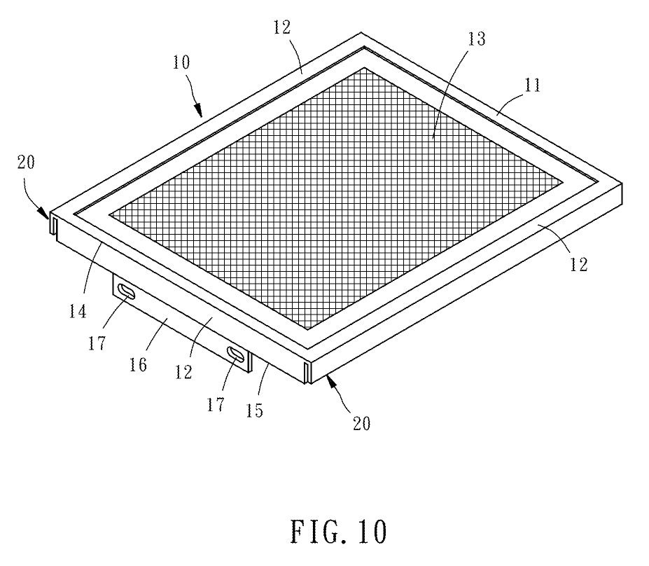

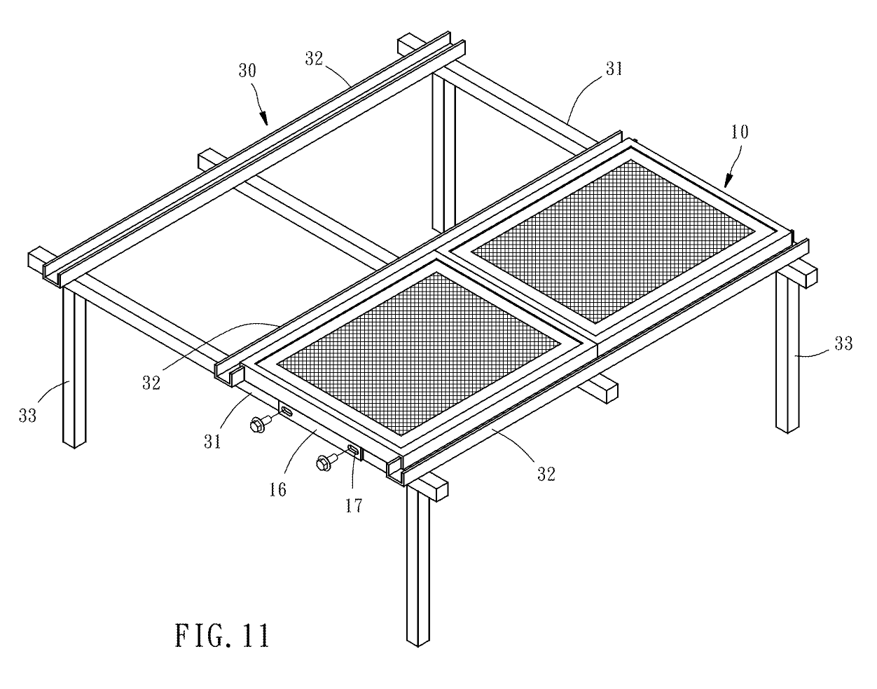

When the present invention is mounted on the beam frame structure 30, there are many ways to fix solar panel frame assembly to the beam frame structure 30, such as by using clamps or fasteners, or by using one side of the transverse bar 11 or the longitudinal bar 12 of the rectangular frame 10 for fixation. FIGS. 10 and 11 illustrate a solar panel frame assembly in accordance with a fifth embodiment of the present invention. This fifth embodiment is substantially similar to the aforesaid first embodiment with the exception that an extension plate 18 is provided at a bottom side of each of the two transverse bar 11 of the rectangular frame 10 and extended far from the bottom surface 15. The extension plate 16 has at least one mounting hole 17. The rectangular frame 10 can be locked to the beam 31 of the beam frame structure 30 by bolting through the mounting hole 17, and the same structure of extension plate can also be disposed on each longitudinal bar 12.

The structure disclosed by the invention is easy to install and easy to maintain. The solar panel frame assembly can be directly used as a roofing building material, and the solar panel frame assembly is not required to be placed on the roof to save the building materials and space.

What is claimed is:

1. A solar panel frame assembly, comprising a rectangular frame formed of two opposed transverse bars and two opposed longitudinal bar and holding therein a solar panel, said rectangular frame defining a top surface and an opposing bottom surface, each said longitudinal bar having an outer side thereof provided with a hanging portion, said hanging portion comprising a transverse segment and a longitudinal segment, said transverse segment extended from the outer side of the associating said longitudinal bar along the long axis direction of said transverse bars, said longitudinal segment extended from a distal end of said transverse segment toward said bottom surface of said rectangular frame, such that a gap is formed between said longitudinal segment and the adjacent said longitudinal bar.

2. The solar panel frame assembly, as claimed in claim 1, wherein said transverse segment of said hanging portion is arch-shaped.

3. The solar panel frame assembly, as claimed in claim 1, wherein one said transverse bar has an outer side thereof provided with a hanging portion.

4. The solar panel frame assembly, as claimed in claim 3, wherein said longitudinal segment of each said hanging portion extends toward said bottom surface of said rectangular frame.

5. The solar panel frame assembly, as claimed in claim 1, wherein each of said two transverse bars has an outer side thereof provided with a hanging portion.

6. The solar panel frame assembly, as claimed in claim 5, wherein the orientation of the said hanging portion at one said transverse bar is same as the orientation of the said hanging portions at said two longitudinal bars with the respective gaps extended toward said bottom surface of said solar panel frame assembly, and the orientation of the said hanging portion at the other said transverse bar is opposite to the direction of the gaps of the other three hanging portions.

7. The solar panel frame assembly, as claimed in claim 6, wherein the said longitudinal segment of the said hanging portion of one said transverse bar extends toward said top surface of said solar panel frame assembly, and the longitudinal segments of the other three said hanging portions extends toward said bottom surface of said solar panel frame assembly.

8. The solar panel frame assembly, as claimed in claim 5, wherein the said longitudinal segment of each said hanging portion extends toward said bottom surface of said rectangular frame.

9. The solar panel frame assembly, as claimed in claim 6, wherein when two same solar panel frame assemblies are mounted adjacent to each other, the said hanging portion of one said transverse bar of one said solar panel frame assembly is hooked up with the said hanging portion of one said transverse bar of the other said solar panel frame assembly, enabling the said longitudinal segment of the said hanging portion of one said transverse bar of one said solar panel frame assembly to engage into the said gap in the said hanging portion of one said transverse bar of the other said solar panel frame assembly.
